(19) United States
(12) Patent Application Publication
(10) Pub. No.: US 2010/0042864 A1
(43) Pub. Date: Feb. 18, 2010

(54) SYSTEM AND METHOD FOR MANAGING APPLICATION

(75) Inventor: KIM-YEUNG SIP, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/346,840

(22) Filed: Dec. 31, 2008

(30) Foreign Application Priority Data
Aug. 13, 2008 (CN) 200810303738.X

(51) Int. Cl. G06F 1/08

(52) U.S. Cl. 713/501

(57) ABSTRACT

A system for managing an application includes a clock unit for generating a plurality of predetermined time signals, a counting unit, a storage unit and a processing unit. The counting unit tracks an invoking count when the application has been executed between two predetermined time signals. The storage unit stores an aging table. The aging table includes a collection of ordered logical pointers and a collection of age values, where each logical pointer is associated with an age value. The application includes a logical pointer. The age values have a predetermined increment when the logical pointer is changed forward. The processing unit increases the logical pointer by a small value if the invoking count is bigger than a predetermined value and increases a larger value otherwise when the later predetermined time signal of the two predetermined time signals comes.

### BACKGROUND

1. Technical Field

The disclosure relates to application management and, particularly, to a system and a method for managing an application.

2. Description of the Related Art

In an intelligent robot system, numerous applications are designed to give the robot physiological functions, such as walking, running, and talking. As robotic technology progresses, more functionalities and applications are added to the robot system, and previous functionalities and applications may be redundant because they may never be needed and thus adding bulk to the operating software and even slowing down the robot system. As a result, manual deletion and/or management of the applications are required, which is inconvenient.

What is needed, therefore, is to provide a system and a method for managing an application.

### BRIEF DESCRIPTION OF THE DRAWINGS

FIG. 1 is a functional block diagram of a system for managing an application according to an exemplary embodiment.

FIG. 2 is a functional block diagram of a system for managing an application according to another exemplary embodiment.

FIG. 3 is a schematic view of an age value used in the system of FIG. 2 according to an exemplary embodiment.

FIG. 4 is a flowchart of a method for managing an application according to an exemplary embodiment.

### DETAILED DESCRIPTION OF THE EMBODIMENTS

All of the processes described below may be embodied in, and fully automated via, software code modules executed by one or more general purpose computers or processors. The code modules may be stored in any type of computer-readable medium or other computer storage device. Some or all of the methods may alternatively be embodied in specialized computer hardware.

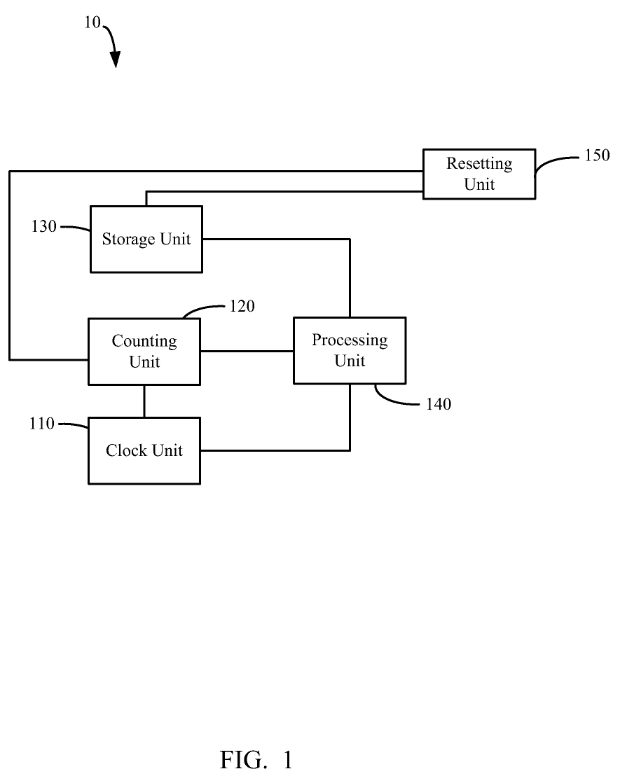

Referring to FIG. 1, a system 10 for managing an application according to an exemplary embodiment includes a clock unit 110, a counting unit 120, a storage unit 130, a processing unit 140, and a resetting unit 150.

The clock unit 110 is configured for generating a plurality of predetermined time signals periodically. A time interval between two sequential time signals can be pre-set and changed during use. The clock unit 110 can be used as a system clock of a device (e.g., a robot) where the system is added to.

The counting unit 120 is configured for tracking an invoking count that reflects a count/number of times that the application is executed between two consecutive predetermined time signals.

The storage unit 130 stores an application and an age table (see Table 1). The application includes a logical pointer and a flag. The flag carries a flag bit indicating the execution status of the application. The flag bit changes from a first value to a second value if the application has been invoked. For example, if the flag bit is ‘0’, it indicates that the application has never been invoked. If the flag bit is ‘1’, it indicates that the application has been invoked. The flag bit is initially set to ‘0’. When the flag bit has changed from ‘0’ to ‘1’, the counting unit 120 tracks the invoking count by adding one count to the invoking count, reflecting a total invoking count of the application.

The age table includes a collection of logical pointers PT₁, PT₂, . . . , PTⱼ and a collection of age values O₁, O₂, . . . , Oⱼ, wherein each logical pointer PTⱼ is associated with an age value Oⱼ, where j can be any natural number. The age value Oⱼ indicates how old the application Pᵢ is. Therefore, the greater the age value Oⱼ, the older the application.

Table 1 shows a relationship between the logical pointers and the age values. In the illustrated embodiment, PT₁<PT₂< . . . <PTⱼ; and O₁<O₂< . . . <Oⱼ. The logical pointer of the application initially is set to PT₁. That is, initial age value of the application is set as the age value O₁, as shown in Table 1.

TABLE 1

| Logical Pointer | Age value |
|---|---|
| PT₁ | O₁ |
| PT₂ | O₂ |
| PT₃ | O₃ |
| . . . | . . . |
| PTⱼ | Oⱼ |

The processing unit 140 is configured for increasing the logical pointer of the application by a small value if the invoking count is bigger than a predetermined value and increasing by a larger value otherwise, when the later predetermined time signal of the two consecutive predetermined time signals comes. The logical pointer of the application is increased to a succeeding logical pointer PTⱼ. Therefore, the age value of the application increases as the logical pointer of the application is changed forward. The predetermined value may be pre-set according to practical usage of the robot and may be changeable during usage of the robot. In this way, the application frequently invoked ages more slowly than applications less-frequently invoked during the time interval between two consecutive predetermined time signals.

The resetting unit 150 is configured for resetting the flag bit ‘1’ into the flag bit ‘0’ once the flag bit ‘1’ is detected by the resetting unit 150 and is configured for resetting the counting unit 120 when increase of the logical pointer of the application is finished.

The processing unit 140 is further configured for detecting whether the age value associated with the logical pointer of the application, after increasing the logical pointer, is greater than a predetermined age value, and configured for deleting the application when the age value is greater than the predetermined age value. Therefore, the application that is “old enough” is purged.

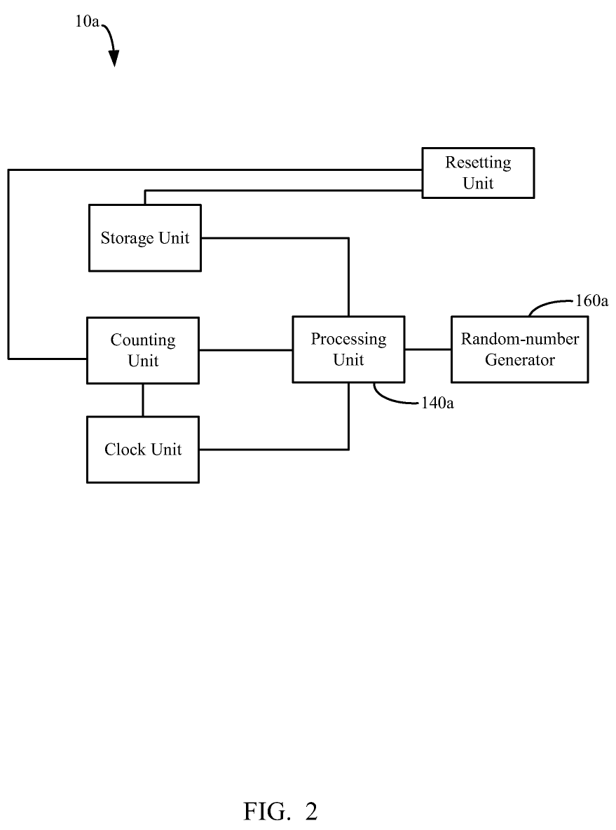

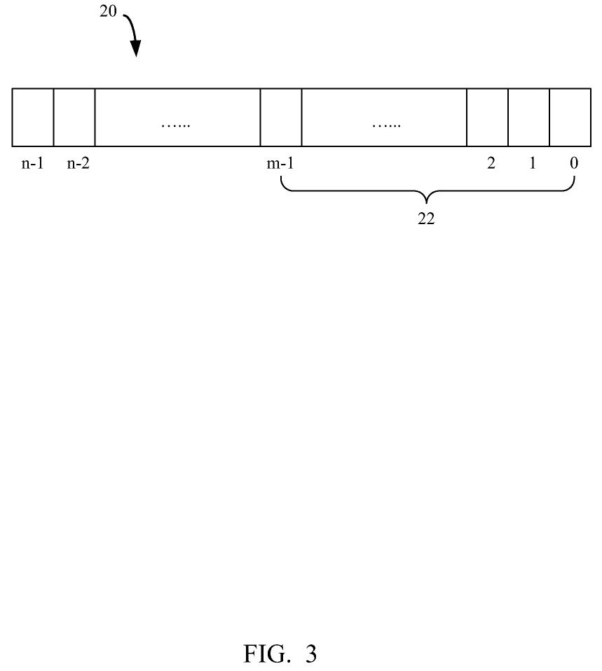

Referring to FIGS. 2 and 3, a system 10a for managing an application according to another embodiment is shown. Differences between the system 10a in this embodiment and the system 10 in the first embodiment are that the system 10a further includes a random-number generator 160a, and each logical pointer includes a n-bit binary digit 20, where n can be any natural number.

The random-number generator 160a is configured for generating m-bit random binary digit 22 during the interval between two predetermined consecutive time signals, where m can be any natural number and is smaller than n. The random binary digit 22 may be represented as white noise. The processing unit 140a is further configured for writing the m-bit random binary digit 22 to the logical pointer when the logical pointer of the application is to be increased.

The m-bit random binary digit 22 is generated according to the normal distribution. Probability of an m-bit random binary digit 22 being generated, which does not change the logical pointer, is maximal.

As shown in FIG. 3, each logical pointer includes an n-bit binary digit 20. The logical pointer may be at a pre-set m bits (m<n) to allow the processing unit 150a to write the m-bit random binary digit 22 thereinto.

After being written into the m-bit random binary digit 22, the logical pointer may be increased to a succeeding logical pointer. As a result, the age value is also changed. The white noise is added in the aging process of the application. The white noise may be simulated as an ambient influence on the robot where the system is used.

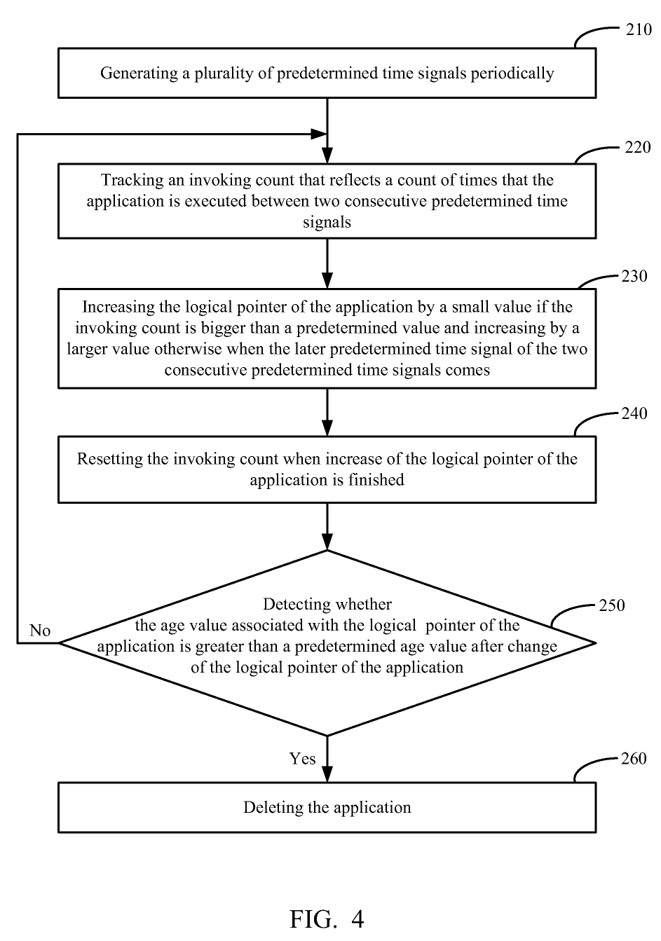

Referring to FIG. 4, a method for managing an application includes steps 210 through step 260. Step 210: generating a plurality of predetermined time signals periodically. Step 220: tracking an invoking count that reflects a count of times that the application is executed between two consecutive predetermined time signals. Step 230: increasing the logical pointer of the application by a small value if the invoking count is bigger than a predetermined value and increasing by a larger value otherwise, when the later predetermined time signal of the two consecutive predetermined time signals comes. Step 240: resetting the invoking count when increase of the logical pointer of the application is finished. Step 250: detecting whether the age value associated with the logical pointer of the application is greater than a predetermined age value after increase of the logical pointer of the application. Step 260: deleting the application when the age value is greater than the predetermined age value.

In summary, the system and method can increase a logical pointer of application by a small value when the application is frequently executed during two time signals. As a result, the less-frequently-used application during two predetermined time signals age faster than those that are frequently used. When the age value of the application is greater than a predetermined age value, the system can delete the application. Therefore, “adequately-old” application may be purged. Furthermore, white noise simulated as an ambient influence on the robot where the system is used is added to the aging process of the application.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A system for managing an application, the application comprising a logical pointer, the system comprising:
a clock unit capable of generating a plurality of predetermined time signals;
a counting unit configured for tracking an invoking count that reflects a count of times that the application is executed between two consecutive predetermined time signals;
a storage unit for storing an aging table, the aging table comprising a collection of ordered logical pointers and a collection of corresponding age values, where each logical pointer is associated with an age value, the age values having a predetermined increment when the logical pointer is changed forward; and
a processing unit configured for increasing the logical pointer by a small value if the invoking count is bigger than a predetermined value and increasing by a larger value otherwise when the later predetermined time signal of the two consecutive predetermined time signals comes.

2. The system as claimed in claim 1, wherein the application further comprises a flag, the flag carrying a flag bit, the flag bit changing from a first value to a second value if the application has been invoked; the application managing system further comprises a resetting unit, the resetting unit being configured for resetting the second value into the first value once the second value is detected by the resetting unit, the counting unit tracks the presence of the second value by adding one count to the invoking count.

3. The system as claimed in claim 2, wherein the resetting unit is configured for resetting the counting unit when increase of the logical pointer of the application is finished.

4. The system as claimed in claim 1, wherein each of the collection of the logical pointers comprises an n-bit binary digit, and n is natural number.

5. The system as claimed in claim 4, further comprising a random-number generator, the random-number generator being configured for generating an m-bit random binary digit, m is natural number and is smaller than n; the processing unit being configured for writing the m-bit random binary digit to the logical pointer when the logical pointer is to be increased.

6. The system as claimed in claim 5, wherein the m-bit random binary digit is generated according to the normal distribution.

7. The system as claimed in claim 1, wherein the processing unit is further configured for detecting whether the age value associated with the logical pointer of the application is greater than a predetermined age value and deleting the application when the age value is greater a predetermined age value.

8. A method for managing an application installed on a system, the system comprising a storage unit for storing an aging table, the aging table comprising a collection of ordered logical pointers and a collection of corresponding age values, where each logical pointer is associated with an age value, the application comprising a logical pointer, the age values having a predetermined increment when the logical pointer is changed forward, the method comprising:
generating a plurality of predetermined time signals;
tracking an invoking count that reflects a count of times that the application is executed between two consecutive predetermined time signals; and
increasing the logical pointer of the application by a small value if the invoking count is bigger than a predetermined value and increasing by a larger value otherwise when the later predetermined time signal of the two consecutive predetermined time signals comes.

9. The method as claimed in claim 8, further comprising:
resetting the invoking count when increase of the logical pointer of the application is finished.

10. The method as claimed in claim 8, further comprising:
detecting whether the age value associated with the logical pointer of the application is greater than a predetermined aging after increase of the logical pointer of the application; and
deleting the application when the age value is greater than the predetermined age value.
